(19) United States
(12) Patent Application Publication
(10) Pub. No.: US 2022/0337118 A1
(43) Pub. Date: Oct. 20, 2022

(54) ELECTRIC ACTUATOR

(71) Applicant: NIDEC TOSOK CORPORATION, Kanagawa (JP)

(72) Inventors: Hiroshi SHIRAI, Kanagawa (JP); Tomoki SATO, Kanagawa (JP)

(21) Appl. No.: 17/721,355

(22) Filed: Apr. 15, 2022

(30) Foreign Application Priority Data
Apr. 19, 2021 (JP) 2021-070109

(51) Int. Cl. H02K 5/173; H02K 7/116; H02K 11/215; F16H 15/50; F16H 61/664; F16H 37/12

(52) U.S. Cl. CPC H02K 5/173; H02K 7/116; H02K 11/215; F16H 15/503; F16H 61/664; F16H 37/12

(57) ABSTRACT

One aspect of an electric actuator of the present invention includes: a motor having a motor shaft rotatable about a motor axis; a transmission mechanism coupled to one side in the axial direction of the motor shaft; an output shaft extending in the axial direction of the motor shaft and to which rotation of the motor shaft is transmitted via the transmission mechanism; and a rolling member group including three or more rolling members arranged to surround the motor axis. The motor shaft is a hollow shaft. At least a part of the output shaft is located inside the motor shaft. The motor shaft and the output shaft are supported with each other in the axial direction and the radial direction via the rolling member group.

### CROSS-REFERENCE TO RELATED APPLICATIONS

The present invention claims priority under 35 U.S.C. § 119 to Japanese Patent Application No. 2021-070109 filed on Apr. 19, 2021, the entire content of which is incorporated herein by reference.

### FIELD OF THE INVENTION

The present invention relates to an electric actuator.

### BACKGROUND

An electric actuator including a motor shaft and an output shaft coupled by a transmission mechanism is known. For example, a rotary actuator applied as a power source of a shift-by-wire system that switches the shift of an automatic transmission of a vehicle is conventionally known.

In the electric actuator as described above, there is a possibility that one of the motor shaft and the output shaft is inclined with respect to the other.

### SUMMARY

One aspect of an exemplary electric actuator of the present invention includes: a motor having a motor shaft rotatable about a motor axis; a transmission mechanism coupled to one side in an axial direction of the motor shaft; an output shaft extending in the axial direction of the motor shaft and to which rotation of the motor shaft is transmitted via the transmission mechanism; and a rolling member group including three or more rolling members arranged to surround the motor axis. The motor shaft is a hollow shaft. At least a part of the output shaft is located inside the motor shaft. The motor shaft and the output shaft are supported in the axial direction and the radial direction with each other via the rolling member group.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a sectional view showing an electric actuator according to an embodiment;

FIG. 2 is an exploded perspective view showing a motor shaft, an output shaft, a rolling member group, a retaining member, and a sensor magnet according to the embodiment;

FIG. 3 is a sectional view showing a part of the motor shaft, a part of the output shaft, a second rolling member group, the retaining member, and the sensor magnet according to the embodiment;

FIG. 4 is a sectional view showing a part of the motor shaft, a part of the output shaft, a first rolling member group, and the retaining member according to the embodiment;

FIG. 5 is a view of a transmission mechanism of the embodiment as viewed from above; and

FIG. 6 is a perspective view showing the first rolling member group and the retaining member according to the embodiment.

### DETAILED DESCRIPTION

In each drawing, the Z axis direction is a vertical direction in which a positive side (+Z side) is an upper side and a negative side (−Z side) is a lower side. The axial direction of a motor axis J1 shown as appropriate in each drawing is parallel to the Z axis direction, that is, the vertical direction. In the following description, a direction parallel to the axial direction of the motor axis J1 is simply referred to as “axial direction”. The radial direction about the motor axis J1 is simply referred to as “radial direction”, and the circumferential direction about the motor axis J1 is simply referred to as “circumferential direction”.

In the present embodiment, the lower side corresponds to “one side in the axial direction”, and the upper side corresponds to the “other side in the axial direction”. The vertical direction, the upper side, and the lower side are names simply for describing the relative positional relationship of each part, and the actual arrangement relationship or the like may be an arrangement relationship or the like other than the arrangement relationship or the like indicated by these names.

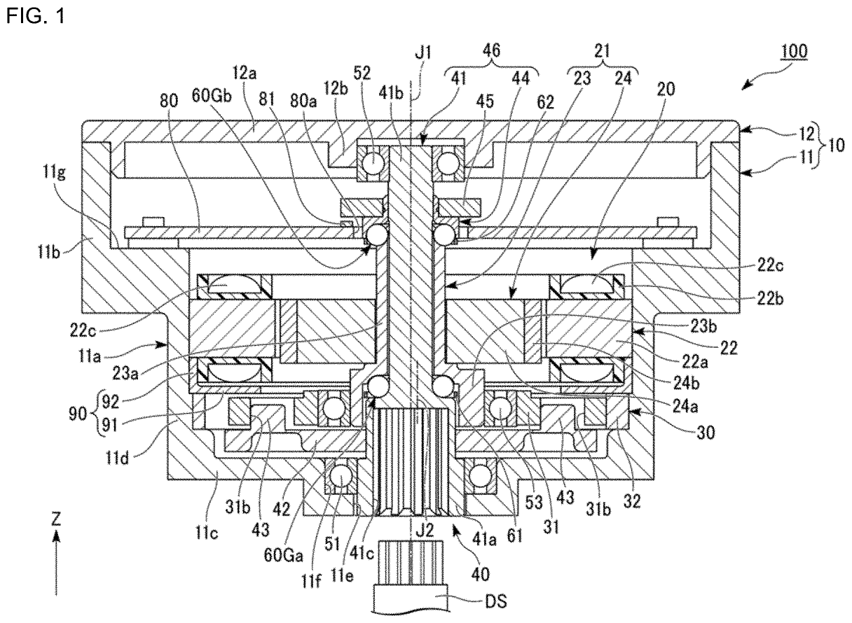

An electric actuator 100 of the present embodiment shown in FIG. 1 is attached to a vehicle. More specifically, the electric actuator 100 is equipped on a park-by-wire type actuator device driven based on a shift operation of a driver of the vehicle, for example. As shown in FIG. 1, the electric actuator 100 includes a case 10, a motor 20, a transmission mechanism 30, an output unit 40, a first bearing 51, a second bearing 52, a third bearing 53, a substrate 80, a rotation sensor 81, a sensor magnet 45, and a partition member 90. The first bearing 51, the second bearing 52, and the third bearing 53 are, for example, ball bearings.

The case 10 accommodate each unit of the electric actuator 100 including the motor 20 and the transmission mechanism 30. The case 10 includes a case body 11 and a cover 12. The case body 11 opens upward. The case body 11 has, for example, a cylindrical shape about the motor axis J1. The case body 11 includes a first accommodation part 11a and a second accommodation part lib.

The first accommodation part 11a is, for example, a lower part of the case body 11. The first accommodation part 11a has a bottom part 11c located on the lower side and a tubular part 11d extending upward from a radially outer edge part of the bottom part 11c. The bottom part 11c has a hole part 11e axially penetrating the bottom part 11c. The hole part 11e is, for example, a circular hole about the motor axis J1. An upper part of the hole part 11e constitutes a first bearing retaining part 11f that retains the first bearing 51 inside thereof. The first bearing 51 is retained by the case body 11 by being held inside the first bearing retaining part 11f. The outer ring of the first bearing 51 is fitted to the inner peripheral surface of the first bearing retaining part 11f, for example.

The second accommodation part 11b is, for example, an upper part of the case body 11. The second accommodation part 11b is connected to the upper side of the first accommodation part 11a. The second accommodation part 11b has a tubular shape that opens upward. The inner diameter of the second accommodation part 11b is larger than the inner diameter of the first accommodation part 11a. The outer diameter of the second accommodation part 11b is larger than the outer diameter of the first accommodation part 11a. A lower end part of the second accommodation part 11b is connected to a radially outer edge part of an upper end part of the tubular part 11d, for example. The inner peripheral surface of the second accommodation part 11b is provided with a step having a step surface 11g facing upward. The step surface 11g is, for example, a surface orthogonal to the axial direction.

The substrate 80 is fixed to the step surface 11g. The substrate 80 has a plate shape whose plate surface faces the axial direction, and extends in the radial direction. The radially outer edge part of the substrate 80 is fixed to the step surface 11g with a screw, for example. The substrate 80 is accommodated inside the second accommodation part 11b. The substrate 80 is located above a rotor body 24 described later. The substrate 80 has a through hole 80a axially penetrating the substrate 80. The through hole 80a is, for example, a circular hole about the motor axis J1. The through hole 80a is provided with an upper part of an output shaft 46 described later that passes through in the axial direction. The plate surface of the substrate 80 is provided with printed wiring not illustrated. Although not illustrated, the substrate 80 is provided with, for example, an inverter circuit that supplies electric power to the motor 20.

A rotation sensor 81 is attached to the substrate 80. The rotation sensor 81 is a sensor capable of detecting rotation of the output shaft 46 described later. In the present embodiment, the rotation sensor 81 is a magnetic sensor. The rotation sensor 81 is, for example, a Hall element such as a Hall IC. For example, a plurality of the rotation sensors 81 may be provided along the circumferential direction. In the present embodiment, the rotation sensor 81 is attached to the peripheral part of the through hole 80a on the upper surface of the substrate 80.

The cover 12 is fixed to the case body 11. The radially outer edge part of the cover 12 is fixed to, for example, the upper end part of the second accommodation part 11b with a screw. The cover 12 closes an upper opening of the case body 11. The cover 12 includes a cover body 12a that covers an upper opening of the case body 11, and a second bearing retaining part 12b that protrudes downward from the cover body 12a. The second bearing retaining part 12b has, for example, a cylindrical shape about the motor axis J1 and opening downward. The second bearing retaining part 12b retains the second bearing 52 inside thereof. Thus, the second bearing 52 is retained by the cover 12. The outer ring of the second bearing 52 is fitted to the inner peripheral surface of the second bearing retaining part 12b, for example.

The motor 20 includes a rotor 21 and a stator 22. The rotor 21 includes a motor shaft 23 and the rotor body 24. That is, the motor 20 includes the motor shaft 23 and the rotor body 24 fixed to the outer peripheral surface of the motor shaft 23. The motor shaft 23 is rotatable about the motor axis J1. The motor shaft 23 is a hollow shaft. The motor shaft 23 has, for example, a cylindrical shape extending in the axial direction about the motor axis J1. The motor shaft 23 is open on both sides in the axial direction. The motor shaft 23 extends upward from the inside of the first accommodation part 11a and protrudes into the inside of the second accommodation part 11b. The motor shaft 23 includes a body part 23a and an eccentric axis part 23b.

The body part 23a is a part to which the rotor body 24 is fixed. The upper end part of the body part 23a is the upper end part of the motor shaft 23. The upper end part of the body part 23a is located inside the second accommodation part 11b. A part of the body part 23a excluding the upper end part is located inside the first accommodation part 11a.

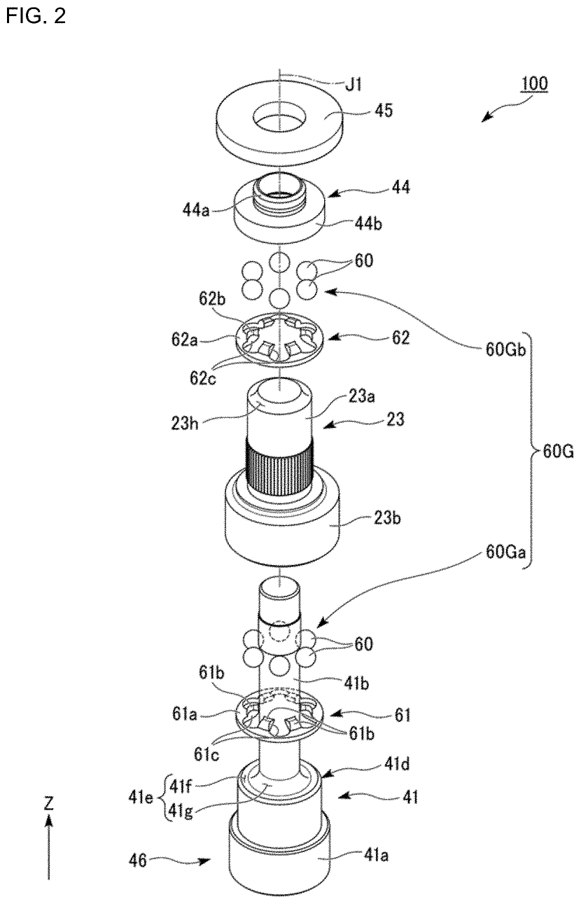

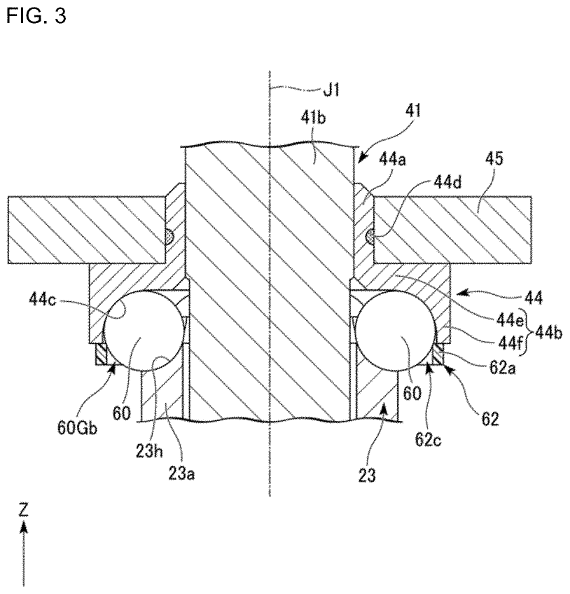

As shown in FIGS. 2 and 3, the upper end surface of the body part 23a, that is, the upper end surface of the motor shaft 23 has a third contact surface 23h. In the present embodiment, the upper end surface of the body part 23a includes the third contact surface 23h. The third contact surface 23h has an annular shape surrounding the motor axis J1. The third contact surface 23h faces upward and obliquely radially outward. The sectional shape of the third contact surface 23h along the axial direction is an arc shape recessed downward and obliquely radially inward. The third contact surface 23h has a shape along the surface of a rolling member 60 included in a second rolling member group 60Gb described later. The third contact surface 23h is located downward toward radially outward.

As shown in FIG. 1, the eccentric axis part 23b is connected to the lower side of body part 23a. The eccentric axis part 23b is located inside the first accommodation part 11a. The lower end part of the eccentric axis part 23b is the lower end part of the motor shaft 23. The eccentric axis part 23b is a part about an eccentric axis J2 eccentric to the motor axis J1. The eccentric axis J2 is parallel to the motor axis J1. An inner ring of the third bearing 53 is fitted and fixed to the eccentric axis part 23b. Thus, the third bearing 53 is fixed to the motor shaft 23.

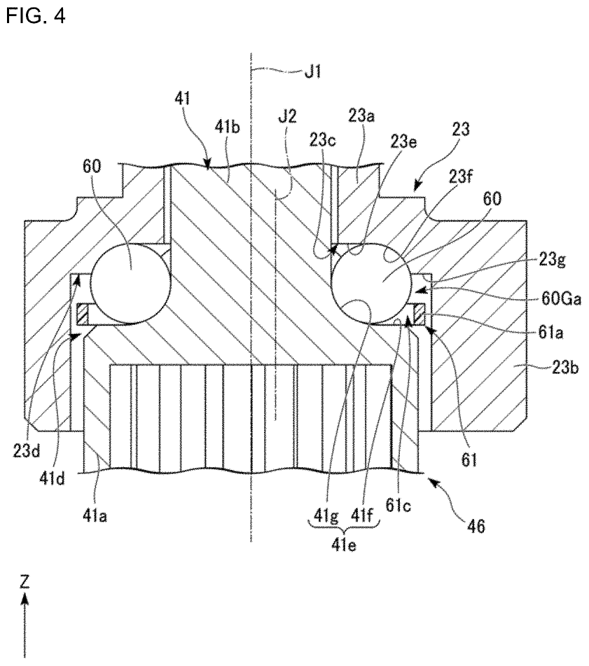

As shown in FIG. 4, the inner diameter of the eccentric axis part 23b is larger than the inner diameter of the body part 23a. The inner peripheral surface of the eccentric axis part 23b has a cylindrical shape about the motor axis J1. A first step part 23c is provided between the inner peripheral surface of the body part 23a and the inner peripheral surface of the eccentric axis part 23b in the axial direction. The first step part 23c has a first step surface 23d facing downward. That is, the inner peripheral surface of the motor shaft 23 is provided with the first step part 23c having the first step surface 23d facing downward. The first step surface 23d has an annular shape surrounding the motor axis J1. The first step surface 23d has flat surfaces 23e and 23g and a first contact surface 23f.

The flat surfaces 23e and 23g are annular flat surfaces orthogonal to the axial direction and surrounding the motor axis J1. The flat surface 23e is connected to the lower end part of the inner peripheral surface of the body part 23a. The flat surface 23g is connected to the upper end part of the inner peripheral surface of the eccentric axis part 23b. The flat surface 23g is located radially outside and below the flat surface 23e.

The first contact surface 23f connects the radially outer peripheral edge part of the flat surface 23e and the radially inner peripheral edge part of the flat surface 23g. The first contact surface 23f faces downward and obliquely radially inward. The sectional shape of the first contact surface 23f along the axial direction is an arc shape recessed upward and obliquely radially outward. The first contact surface 23f has a shape along the surface of the rolling member 60 included in a first rolling member group 60Ga described later. The first contact surface 23f is located downward toward radially outward.

As shown in FIG. 1, the rotor body 24 is fixed to the outer peripheral surface of the body part 23a, that is, the outer peripheral surface of the motor shaft 23. The rotor body 24 is fixed to a lower part of the outer peripheral surface of the body part 23a. The rotor body 24 is accommodated inside the first accommodation part 11a. The rotor body 24 includes a cylindrical rotor core 24a fixed to the outer peripheral surface of the motor shaft 23 and a rotor magnet 24b fixed to the rotor core 24a.

The stator 22 opposes the rotor 21 in the radial direction via a gap. The stator 22 is located radially outside the rotor 21. The stator 22 is accommodated inside the first accommodation part 11a. The stator 22 includes an annular stator core 22a surrounding the radially outer side of the rotor body 24, an insulator 22b attached to the stator core 22a, and a plurality of coils 22c attached to the stator core 22a via the insulator 22b. The outer peripheral surface of the stator core 22a is fixed to, for example, the inner peripheral surface of the tubular part 11d.

The transmission mechanism 30 is located below the rotor body 24 and the stator 22 inside the first accommodation part 11a. In the present embodiment, the transmission mechanism 30 is a speed reduction mechanism that decelerates the rotation of the motor shaft 23 and transmits the rotation to the output shaft 46. The transmission mechanism 30 includes an external gear 31, an internal gear 32, an output flange part 42, and a plurality of protrusion parts 43.

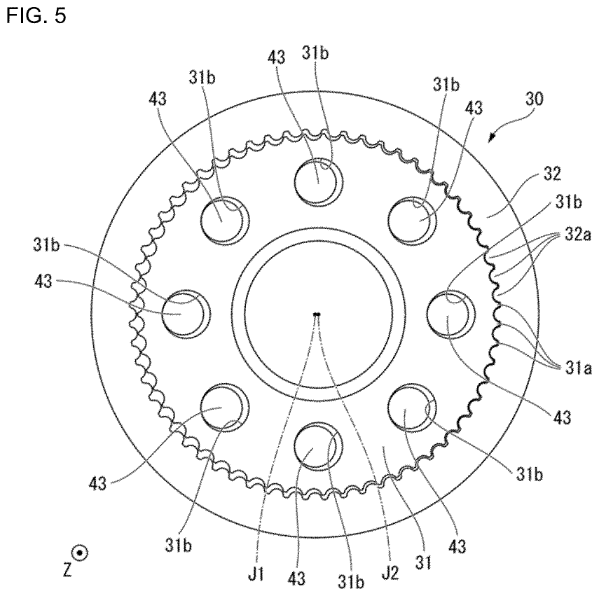

The external gear 31 has a substantially annular plate shape extending along a plane orthogonal to the axial direction about the eccentric axis J2 of the eccentric axis part 23b. As shown in FIG. 5, the radially outer surface of the external gear 31 is provided with a gear part including a plurality of tooth parts 31a. As shown in FIG. 1, the external gear 31 is coupled to the eccentric axis part 23b via the third bearing 53. Thus, the transmission mechanism 30 is coupled to the lower side of the motor shaft 23. In the present embodiment, the transmission mechanism 30 is coupled to the lower end part of the motor shaft 23. The external gear 31 is fitted to the outer ring of the third bearing 53 from radially outside. Due to thus, the third bearing 53 couples the motor shaft 23 and the external gear 31 so as to be relatively rotatable about the eccentric axis J2.

The external gear 31 has a plurality of hole parts 31b recessed upward from the lower surface of the external gear 31. In the present embodiment, the hole part 31b axially penetrates the external gear 31. As shown in FIG. 5, the plurality of hole parts 31b are arranged to surround the motor axis J1. More specifically, the plurality of hole parts 31b are arranged at equal intervals over the entire circumference along the circumferential direction about the eccentric axis J2. For example, eight hole parts 31b are provided. The shape of the hole part 31b viewed along the axial direction is, for example, a circular shape. The inner diameter of the hole part 31b is larger than the outer diameter of the part of the protrusion part 43 inserted into the hole part 31b.

The internal gear 32 surrounds the radially outer side of the external gear 31 and meshes with the external gear 31. The internal gear 32 has an annular shape about the motor axis J1. As shown in FIG. 1, in the present embodiment, the internal gear 32 is fixed to the case 10. The outer peripheral surface of the internal gear 32 is fitted and fixed to an inner peripheral surface of the first accommodation part 11a. As shown in FIG. 5, the inner peripheral surface of the internal gear 32 is provided with a gear part having a plurality of tooth parts 32a. The gear part of the internal gear 32 meshes with the gear part of the external gear 31. More specifically, the gear part of the internal gear 32 meshes with the gear part of the external gear 31 in a part of the circumferential direction.

The output flange part 42 is a part of the output unit 40. As shown in FIG. 1, the output flange part 42 is disposed to oppose the lower side of the external gear 31. A gap is provided between the output flange part 42 and the external gear 31 in the axial direction. The output flange part 42 has an annular plate shape expanding in the radial direction about the motor axis J1, for example. The output flange part 42 extends radially outward from a part located below the motor shaft 23 in an output shaft body 41 described later.

The protrusion part 43 protrudes upward from the output flange part 42 toward the external gear 31. In the present embodiment, the protrusion part 43 and the output flange part 42 are a part of the same single member. As shown in FIG. 5, the plurality of protrusion parts 43 have a columnar shape. The plurality of protrusion parts 43 are arranged to surround the motor axis J1. For example, the plurality of protrusion parts 43 are arranged at equal intervals over the entire circumference along the circumferential direction. For example, eight protrusion parts 43 are provided.

As shown in FIG. 1, the plurality of protrusion parts 43 are inserted into the plurality of respective hole parts 31b from below. The outer diameter of the part of the protrusion part 43 inserted into the hole part 31b is smaller than the inner diameter of the hole part 31b. The outer peripheral surface of the protrusion part 43 is inscribed with the inner peripheral surface of the hole part 31b. The plurality of protrusion parts 43 support the external gear 31 to be swingable about the motor axis J1 via the inner peripheral surface of the hole part 31b.

The output unit 40 is a part that outputs drive force of the electric actuator 100. Rotation of the motor shaft 23 is transmitted to the output unit 40 via the transmission mechanism 30. The output unit 40 includes the output shaft 46 and the output flange part 42. That is, the electric actuator 100 includes the output shaft 46 and the output flange part 42. In the present embodiment, the output shaft 46 and the output flange part 42 are separated from each other. Note that the output shaft 46 and the output flange part 42 may be a part of the same single member.

The output shaft 46 extends in the axial direction of the motor shaft 23. The output shaft 46 is disposed coaxially with the motor shaft 23. That is, the output shaft 46 is rotatable about the motor axis J1. At least a part of the output shaft 46 is located inside the motor shaft 23. In the present embodiment, the output shaft 46 passes through inside the motor shaft 23 from blow and protrudes upward relative to the motor shaft 23. The output shaft 46 protrudes to both sides in the axial direction relative to the motor shaft 23. In the present embodiment, a gap is provided over the entire circumference between the outer peripheral surface of the output shaft 46 and the inner peripheral surface of the motor shaft 23. The outer peripheral surface of the output shaft 46 and the inner peripheral surface of the motor shaft 23 are not in contact with each other. The radial gap between the outer peripheral surface of the output shaft 46 and the inner peripheral surface of the motor shaft 23 may be provided with lubricating oil, for example.

The output shaft 46 includes the axially extending output shaft body 41 and an attachment member 44 fixed to the outer peripheral surface of the output shaft body 41. In the present embodiment, the output shaft body 41 and the attachment member 44 are separate from each other. Note that the output shaft body 41 and the attachment member 44 may be a part of the same single member. The output shaft body 41 is rotatably supported by the first bearing 51 and the second bearing 52. The output shaft body 41 includes a coupling part 41a and an extension part 41b.

The coupling part 41a is a lower part of the output shaft body 41. The lower end part of the coupling part 41a is the lower end part of the output shaft body 41. The lower end part of the coupling part 41a is inserted inside the hole part 11e. The lower end part of the coupling part 41a is, for example, at the same axial position as the lower end part of the hole part 11e. The upper end part of the coupling part 41a is inserted inside the eccentric axis part 23b. The outer diameter of the coupling part 41a is larger than the outer diameter of the extension part 41b. The coupling part 41a is rotatably supported about the motor axis J1 by the first bearing 51. Thus, the first bearing 51 rotatably supports a part of the output shaft 46 located below the motor shaft 23.

The coupling part 41a has a coupling recess part 41c recessed upward from the lower end surface of the coupling part 41a. The coupling recess part 41c opens downward and is exposed to the outside of the case 10. The coupling recess part 41c has a circular shape about the motor axis J1 when viewed from below, for example. Since the coupling recess part 41c is provided, the coupling part 41a has a cylindrical shape opening downward about the motor axis J1.

The inner peripheral surface of the coupling recess part 41c is provided with a spline groove. A driven shaft DS is inserted from below and coupled to the inside of the coupling recess part 41c. Due to this, the driven shaft DS is coupled to the coupling part 41a. More specifically, the spline part provided on the outer peripheral surface of the driven shaft DS is fitted into the spline groove provided on the inner peripheral surface of the coupling recess part 41c, whereby the output shaft body 41 and the driven shaft DS are coupled. The drive force of the electric actuator 100 is transmitted to the driven shaft DS via the output shaft body 41. Thus, the electric actuator 100 rotates the driven shaft DS about the motor axis J1.

The extension part 41b is an upper part of the output shaft body 41. The upper end part of the extension part 41b is the upper end part of the output shaft body 41. The extension part 41b extends upward from a radial center part at the upper end part of the coupling part 41a. The extension part 41b has a columnar shape extending in the axial direction about the motor axis J1. The axial dimension of the extension part 41b is larger than the axial dimension of the coupling part 41a. The extension part 41b is inserted inside the motor shaft 23, which is a hollow shaft. The extension part 41b is inserted inside the motor shaft 23 from the lower side of the motor shaft 23 and protrudes upward relative to the motor shaft 23. The extension part 41b is axially passed through the through hole 80a of the substrate 80. The upper end part of the extension part 41b is supported by the second bearing 52 rotatably about the motor axis J1. Thus, the second bearing 52 rotatably supports a part of the output shaft 46 located above the motor shaft 23.

As shown in FIG. 2, the outer peripheral surface of the output shaft 46 is provided with a second step part 41d. In the present embodiment, the second step part 41d is provided on the outer peripheral surface of the output shaft body 41. The second step part 41d is provided between the coupling part 41a and the extension part 41b in the axial direction. The second step part 41d has a second step surface 41e facing upward. The second step surface 41e has an annular shape surrounding the motor axis J1. As shown in FIG. 4, the second step surface 41e is located below the first step surface 23d. The second step surface 41e has a flat surface 41f and a second contact surface 41g. The flat surface 41f is an annular flat surface orthogonal to the axial direction and surrounding the motor axis J1. The flat surface 41f is a radially outer peripheral edge part of the second step surface 41e.

The second contact surface 41g connects the radially inner peripheral edge part of the flat surface 41f and the outer peripheral surface of the extension part 41b. The second contact surface 41g faces upward and obliquely radially outward. The sectional shape of the second contact surface 41g along the axial direction is an arc shape recessed downward and obliquely radially inward. The second contact surface 41g has a shape along the surface of the rolling member 60 included in a first rolling member group 60Ga described later. The second contact surface 41g is located upward toward radially inward. The second contact surface 41g is located below and obliquely radially inward of the first contact surface 23f.

As shown in FIG. 1, the attachment member 44 is fixed to a part of the extension part 41b located above the motor shaft 23. The attachment member 44 is a member for attaching the sensor magnet 45 to the output shaft body 41. The lower end part of the attachment member 44 is located in the through hole 80a of the substrate 80. As shown in FIG. 3, the attachment member 44 includes a fixed tubular part 44a and an opposing part 44b. That is, the output shaft 46 includes the fixed tubular part 44a and the opposing part 44b.

The fixed tubular part 44a has a cylindrical shape opening on both sides in the axial direction about the motor axis J1. The fixed tubular part 44a is fitted and fixed to the outer peripheral surface of the extension part 41b. The fixed tubular part 44a is fixed to the extension part 41b by press fitting, for example. The sensor magnet 45 is fixed to the outer peripheral surface of the fixed tubular part 44a. The outer peripheral surface of the fixed tubular part 44a is provided with an annular groove 44d surrounding the motor axis J1. The annular groove 44d is filled with, for example, an adhesive for fixing the sensor magnet 45.

The sensor magnet 45 has an annular shape surrounding the motor axis J1. The sensor magnet 45 is fitted to the outer peripheral surface of the fixed tubular part 44a. The sensor magnet 45 is fixed to the outer peripheral surface of the fixed tubular part 44a with an adhesive, for example. The lower surface of the sensor magnet 45 is in contact with the upper surface of the opposing part 44b. The sensor magnet 45 protrudes radially outward relative to the attachment member 44. As shown in FIG. 1, the radially outer edge part of the sensor magnet 45 is disposed to oppose the upper side of the rotation sensor 81. The magnetic field of the sensor magnet 45 is detected by the rotation sensor 81. In the present embodiment, the rotation sensor 81 detects the rotation of the sensor magnet 45 by detecting the magnetic field of the sensor magnet 45, and detects the rotation of the output shaft 46.

As shown in FIG. 3, the opposing part 44b protrudes radially outward from the lower end part of the fixed tubular part 44a. The opposing part 44b is disposed to oppose the upper side of the motor shaft 23. The opposing part 44b has an annular wall part 44e and a peripheral wall part 44f. The annular wall part 44e extends radially outward from the lower end part of the fixed tubular part 44a. The annular wall part 44e has an annular shape surrounding the motor axis J1. The peripheral wall part 44f protrudes downward from the radially outer peripheral edge part of the annular wall part 44e. The peripheral wall part 44f has a cylindrical shape surrounding the motor axis J1.

The opposing part 44b has a fourth contact surface 44c facing downward and radially inward. In the present embodiment, the fourth contact surface 44c connects the lower surface of the annular wall part 44e and the inner peripheral surface of the peripheral wall part 44f. The sectional shape of the fourth contact surface 44c along the axial direction is an arc shape recessed upward and obliquely radially outward. The fourth contact surface 44c has a shape along the surface of the rolling member 60 included in the second rolling member group 60Gb described later. The fourth contact surface 44c is located downward toward radially outward. The fourth contact surface 44c is located above and obliquely radially outward of the third contact surface 23h.

As shown in FIG. 2, the electric actuator 100 includes a rolling member group 60G including three or more rolling members 60 arranged to surround the motor axis J1. The rolling member 60 is a sphere. The rolling member 60 is made of metal, for example. In the present embodiment, the rolling member group 60G includes the first rolling member group 60Ga and the second rolling member group 60Gb. In each of the first rolling member group 60Ga and the second rolling member group 60Gb, three or more of the rolling members 60 are arranged at equal intervals over the entire circumference along the circumferential direction. In the present embodiment, the first rolling member group 60Ga and the second rolling member group 60Gb each includes six rolling members 60. In the present embodiment, the rolling members 60 included in the first rolling member group 60Ga and the rolling members 60 included in the second rolling member group 60Gb have the same shape and the same size.

The first rolling member group 60Ga is the rolling member group 60G located below the rotor body 24. As shown in FIG. 4, the first rolling member group 60Ga is located between the first contact surface 23f and the second contact surface 41g. In the present embodiment, each rolling member 60 of the first rolling member group 60Ga is held between the first contact surface 23f and the second contact surface 41g in a direction inclined by 45° in the radial direction with respect to the axial direction. The first rolling member group 60Ga is located between the first step surface 23d and the second step surface 41e in the axial direction. The first rolling member group 60Ga is located between the extension part 41b and the eccentric axis part 23b in the radial direction. The rolling member 60 included in the first rolling member group 60Ga is in contact with the first contact surface 23f and the second contact surface 41g. Thus, the motor shaft 23 and the output shaft body 41 are supported with each other in the axial direction and the radial direction via the first rolling member group 60Ga.

The second rolling member group 60Gb is the rolling member group 60G located above the rotor body 24. As shown in FIG. 3, the second rolling member group 60Gb is located between the third contact surface 23h and the fourth contact surface 44c. In the present embodiment, each rolling member 60 of the second rolling member group 60Gb is held between the third contact surface 23h and the fourth contact surface 44c in a direction inclined by 45° in the radial direction with respect to the axial direction. The second rolling member group 60Gb is located between the opposing part 44b and the motor shaft 23 in the axial direction. The second rolling member group 60Gb is located between the extension part 41b and the peripheral wall part 44f in the radial direction. The rolling member 60 included in the second rolling member group 60Gb is in contact with the third contact surface 23h and the fourth contact surface 44c. Thus, the motor shaft 23 and the attachment member 44 are supported with each other in the axial direction and the radial direction via the second rolling member group 60Gb. As described above, in the present embodiment, the motor shaft 23 and the output shaft 46 are supported with each other in the axial direction and the radial direction via the two rolling member groups 60G.

As shown in FIG. 2, the electric actuator 100 includes retaining members 61 and 62 that retain the rolling member group 60G in a state where the rolling member 60 is rotatable. The retaining member 61 is a retaining member that retains the first rolling member group 60Ga. The retaining member 62 is a retaining member that retains the second rolling member group 60Gb. In the present embodiment, the retaining members 61 and 62 are made of resin.

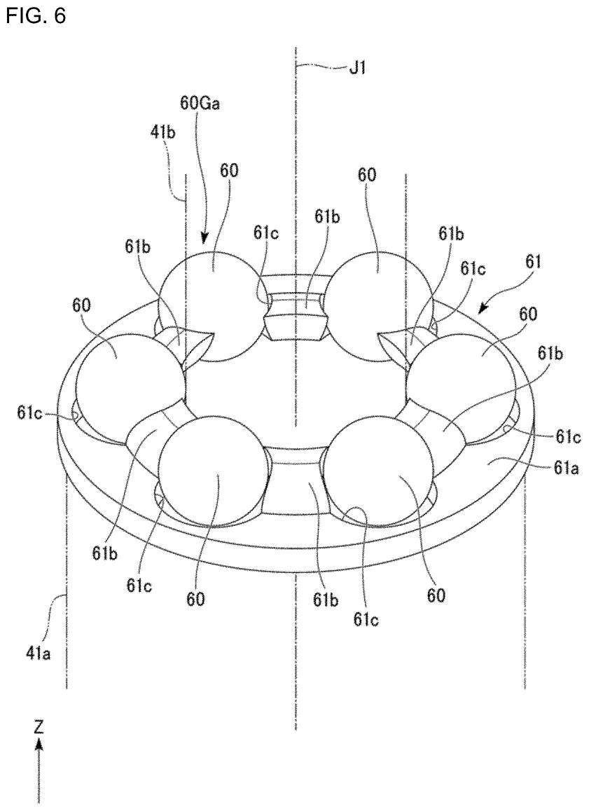

As shown in FIG. 6, the retaining member 61 is an annular member surrounding the motor axis J1. The axial dimension of the retaining member 61 is smaller than the outer diameter of the rolling member 60. The retaining member 61 includes a pressing part 61a and a partition part 61b. In the present embodiment, the pressing part 61a has an annular shape surrounding the motor axis J1. The pressing part 61a is located radially outside the rolling member 60. In the example shown in FIG. 6, the pressing part 61a is located radially outside the lower part of each rolling member 60 included in the first rolling member group 60Ga.

In the present embodiment, the partition part 61b protrudes radially inward from the inner peripheral surface of the pressing part 61a. A plurality of the partition parts 61b are provided at intervals in the circumferential direction. The plurality of partition parts 61b are arranged at equal intervals over the entire circumference along the circumferential direction. In the present embodiment, six partition parts 61b are provided. Each partition part 61b is located between the rolling members 60 adjacent to each other in the circumferential direction. In the present embodiment, the partition part 61b protrudes upward relative to the pressing part 61a. The circumferential side surface of the partition part 61b has an arc shape along the surface of the rolling member 60 arranged adjacent to the partition part 61b in the circumferential direction. The circumferential dimension of the partition part 61b decreases from the radially outer end part toward the radial center part, and increases from the radial center part toward the radially inner end part.

A pair of the partition parts 61b adjacent to each other in the circumferential direction and a part of the pressing part 61a connecting the radially outer end parts of the pair of partition parts 61b constitute a retaining hole part 61c that retains inside thereof the rolling member 60 included in the first rolling member group 60Ga. A plurality of the retaining hole parts 61c are arranged at equal intervals over the entire circumference along the circumferential direction. In the present embodiment, six retaining hole parts 61c are provided. The retaining hole part 61c axially penetrates the retaining member 61. The retaining hole part 61c has a circular shape when viewed in the axial direction. When viewed in the axial direction, the inner diameter of the retaining hole part 61c is larger than the outer diameter of the rolling member 60. The radially inner end part of the retaining hole part 61c opens radially inward. The inner peripheral surface of the retaining hole part 61c is disposed to surround the rolling member 60.

As shown in FIG. 4, the retaining member 61 is located between the first step surface 23d and the second step surface 41e in the axial direction. The retaining member 61 is located between the extension part 41b and the eccentric axis part 23b in the radial direction. In the example shown in FIG. 4, the retaining member 61 is supported from below by the second step surface 41e. The retaining member 61 is disposed to be axially movable, for example, between the first step surface 23d and the second step surface 41e in the axial direction.

As shown in FIG. 2, the retaining member 62 is an annular member surrounding the motor axis J1. In the present embodiment, the shape of the retaining member 62 is similar to the shape of the retaining member 61. Similarly to the retaining member 61, the retaining member 62 includes a pressing part 62a and a partition part 62b. Similarly to the retaining member 61, in the retaining member 62, a pair of the partition parts 62b adjacent to each other in the circumferential direction and a part of the pressing part 62a connecting the radially outer end parts of the pair of partition parts 62b constitute a retaining hole part 62c that retains inside thereof the rolling member 60 included in the second rolling member group 60Gb.

As shown in FIG. 3, the retaining member 62 is located between the opposing part 44b and the motor shaft 23 in the axial direction. In the example shown in FIG. 3, the retaining member 62 is supported from below by the motor shaft 23. The retaining member 62 protrudes radially outward relative to the body part 23a of the motor shaft 23. The pressing part 62a of the retaining member 62 is located below the peripheral wall part 44f. In the example shown in FIG. 3, the pressing part 62a is in contact with the lower surface of the peripheral wall part 44f.

The pressing part 62a may be disposed below the peripheral wall part 44f with a gap. In this case, when the attachment member 44 is fixed to the output shaft body 41, it is possible to suppress the attachment member 44 from coming into contact with the retaining member 62 before the fourth contact surface 44c comes into contact with the rolling member 60. Therefore, it is possible to suitably bring the fourth contact surface 44c into contact with the rolling member 60. In this case, the retaining member 62 is disposed to be axially movable within the range of the gap between the pressing part 62a and the peripheral wall part 44f.

As shown in FIG. 1, the partition member 90 is located between the stator 22 and the transmission mechanism 30 in the axial direction. The partition member 90 surrounds the motor axis J1. The partition member 90 includes a partition member body 91 and a peripheral wall part 92. The partition member body 91 has an annular shape about the motor axis J1, for example. The partition member body 91 has a plate shape with the plate surface facing the axial direction. The radially inner edge part of the partition member body 91 is located radially outside relative to the radially inner edge part of the insulator 22b. The peripheral wall part 92 protrudes upward from the radially outer edge part of the partition member body 91. The peripheral wall part 92 has, for example, a cylindrical shape about the motor axis J1. The peripheral wall part 92 is fitted and fixed to an inner peripheral surface of the first accommodation part 11a. The upper end part of the peripheral wall part 92 is in contact with the radially outer edge part of the lower end surface of the stator core 22a.

When electric power is supplied to the motor 20 and the motor shaft 23 rotates about the motor axis J1, the eccentric axis part 23b revolves circumferentially about the motor axis J1. The revolution of the eccentric axis part 23b is transmitted to the external gear 31 via third bearing 53, and the external gear 31 swings while changing the position where the inner peripheral surface of the hole part 31b and the outer peripheral surface of the protrusion part 43 are inscribed. Thus, the position where the gear part of the external gear 31 and the gear part of the internal gear 32 mesh with each other changes in the circumferential direction. Therefore, the rotational force of the motor shaft 23 is transmitted to the internal gear 32 via the external gear 31.

In the present embodiment, since the internal gear 32 is fixed to the case 10, it does not rotate. Therefore, the external gear 31 rotates about the eccentric axis J2 by the reaction force of the rotational force transmitted to the internal gear 32. At this time, the orientation in which the external gear 31 rotates is opposite to the orientation in which the motor shaft 23 rotates. The rotation of the external gear 31 about the eccentric axis J2 is transmitted to the output flange part 42 via the hole part 31b and the protrusion part 43. Thus, the output shaft body 41 rotates about the motor axis J1. In this manner, the rotation of the motor shaft 23 is transmitted to the output shaft 46 via the transmission mechanism 30. Since the structure of the transmission mechanism 30 as a speed reduction mechanism has a structure in which the rotation is transmitted via the plurality of protrusion parts 43 as described above, a reduction ratio of the rotation of the output shaft 46 to the rotation of the motor shaft 23 can be relatively increased. Therefore, the rotational torque of the output shaft 46 can be relatively increased.

In the electric actuator 100 of the present embodiment, a worker or the like who assembles the motor shaft 23 and the output shaft 46 first assembles the retaining member 61 to the output shaft body 41. At this time, the extension part 41b is passed through the inside of the retaining member 61, and the retaining member 61 is supported by the second step surface 41e from below. The worker or the like inserts, from above, and retains the rolling member 60 into each of the retaining hole parts 61c of the retaining member 61 assembled to the output shaft body 41. The worker or the like brings the motor shaft 23 close to the output shaft body 41 from above and passes the output shaft body 41 into the motor shaft 23. Thus, the first rolling member group 60Ga retained by the retaining member 61 is brought into a state of being held between the first contact surface 23f and the second contact surface 41g. By being held between the first contact surface 23f and the second contact surface 41g, the first rolling member group 60Ga is suppressed from being detached from the motor shaft 23 and the output shaft 46. At this time, for example, the rotor body 24 is fixed to the motor shaft 23. The worker or the like may fix the rotor body 24 to the motor shaft 23 after assembling the motor shaft 23 to the output shaft body 41.

Next, the worker or the like brings, from above, the retaining member 62 close to the part of the output shaft body 41 protruding upward from the motor shaft 23 to assemble the retaining member 62. At this time, the output shaft body 41 passes through the inside of the retaining member 62. The assembled retaining member 62 is supported from below by the upper end part of the motor shaft 23. The worker or the like inserts, from above, and retains the rolling member 60 into each of the retaining hole parts 62c of the assembled retaining member 62. The worker or the like brings the attachment member 44 close to the output shaft body 41 from above to fix the attachment member 44 to the outer peripheral surface of the output shaft body 41. Thus, the second rolling member group 60Gb retained by the retaining member 62 is brought into a state of being held between the third contact surface 23h and the fourth contact surface 44c. By being held between the third contact surface 23h and the fourth contact surface 44c, the second rolling member group 60Gb suppressed from being detached from the motor shaft 23 and the output shaft 46. The worker or the like fixes the sensor magnet 45 to the attachment member 44 fixed to the output shaft body 41. The worker or the like may fix the sensor magnet 45 to the attachment member 44 before fixing the attachment member 44 to the output shaft body 41.

Note that, in the present description, the “worker or the like” includes a worker and an assembling device that perform each work. Each work may be performed only by a worker, may be performed only by an assembling device, or may be performed by a worker and an assembling device.

According to the present embodiment, the electric actuator 100 includes the rolling member group 60G including the three or more rolling members 60 arranged to surround the motor axis J1. The motor shaft 23 and the output shaft 46 are supported with each other in the axial direction and the radial direction via the rolling member group 60G. Therefore, the motor shaft 23 and the output shaft 46 can be relatively positioned in the radial direction and the axial direction via the rolling member group 60G. This makes it possible to suppress the motor shaft 23 and the output shaft 46 from being inclined with respect to each other. It is possible to suppress the motor shaft 23 and the output shaft 46 from rattling in the axial direction and the radial direction.

The rolling member group 60G can suppress the inner peripheral surface of the motor shaft 23 and the outer peripheral surface of the output shaft 46 from coming into contact with each other. Therefore, it is possible to suppress the inner peripheral surface of the motor shaft 23 and the outer peripheral surface of the output shaft 46 from rubbing with each other. This makes it possible to reduce the loss generated when the motor shaft 23 and the output shaft 46 relatively rotate about the motor axis J1. On the other hand, since the three or more rolling members 60 included in the rolling member group 60G rotate, the relative rotation of the motor shaft 23 and the output shaft 46 about the motor axis J1 can be suitably permitted while suppressing the loss. This makes it possible to improve the transmission efficiency of the rotation from the motor shaft 23 to the output shaft 46. As compared with a case where a rolling bearing such as a ball bearing is used between the motor shaft 23 and the output shaft 46, it is possible to suppress the electric actuator 100 from increasing in size and it is possible to reduce the manufacturing cost of the electric actuator 100.

According to the present embodiment, the rolling member group 60G includes the first rolling member group 60Ga located below the rotor body 24 and the second rolling member group 60Gb located above the rotor body 24. Therefore, by the two rolling member groups 60G, it is possible to suitably support the motor shaft 23 and the output shaft 46 with each other in the axial direction and the radial direction. This makes it possible to further suppress the motor shaft 23 and the output shaft 46 from being inclined with respect to each other. It is possible to further suppress the motor shaft 23 and the output shaft 46 from rattling in the axial direction and the radial direction. It is possible to further suppress the inner peripheral surface of the motor shaft 23 and the outer peripheral surface of the output shaft 46 from rubbing with each other, and it is possible to further improve the transmission efficiency of rotation from the motor shaft 23 to the output shaft 46.

According to the present embodiment, the inner peripheral surface of the motor shaft 23 is provided with the first step part 23c having the first step surface 23d facing downward. The outer peripheral surface of the output shaft 46 is provided with the second step part 41d having the second step surface 41e facing upward and located below the first step surface 23d. The first step surface 23d has the first contact surface 23f facing downward and obliquely radially inward. The second step surface 41e has the second contact surface 41g facing upward and obliquely radially outward. The rolling member 60 included in the first rolling member group 60Ga is in contact with the first contact surface 23f and the second contact surface 41g. When the rolling member 60 comes into contact with the first contact surface 23f and the second contact surface 41g inclined obliquely in the radial direction with respect to the axial direction in this manner, the rolling member 60 can be brought into contact with both the motor shaft 23 and the output shaft 46 in the axial direction and the radial direction. This makes it possible to easily support the motor shaft 23 and the output shaft 46 with each other in the axial direction and the radial direction via the rolling member 60.

According to the present embodiment, the first contact surface 23f and the second contact surface 41g have shapes along the surface of the rolling member 60 included in the first rolling member group 60Ga. Therefore, the surface of the rolling member 60 included in the first rolling member group 60Ga can be suitably brought into contact with the first contact surface 23f and the second contact surface 41g. This makes it possible to more suitably support the motor shaft 23 and the output shaft 46 with each other in the axial direction and the radial direction via the first rolling member group 60Ga.

According to the present embodiment, the upper end surface of the motor shaft 23 has the third contact surface 23h facing upward and obliquely radially outward. The output shaft 46 has the opposing part 44b disposed to oppose the upper side of the motor shaft 23. The opposing part 44b has a fourth contact surface 44c facing downward and radially inward. The rolling member 60 included in the second rolling member group 60Gb is in contact with the third contact surface 23h and the fourth contact surface 44c. When the rolling member 60 comes into contact with the third contact surface 23h and the fourth contact surface 44c inclined obliquely in the radial direction with respect to the axial direction in this manner, the rolling member 60 can be brought into contact with both the motor shaft 23 and the output shaft 46 in the axial direction and the radial direction. This makes it possible to easily support the motor shaft 23 and the output shaft 46 with each other in the axial direction and the radial direction via the rolling member 60.

According to the present embodiment, the third contact surface 23h and the fourth contact surface 44c have shapes along the surface of the rolling member 60 included in the second rolling member group 60Gb. Therefore, the surface of the rolling member 60 included in the second rolling member group 60Gb can be suitably brought into contact with the third contact surface 23h and the fourth contact surface 44c. This makes it possible to more suitably support the motor shaft 23 and the output shaft 46 with each other in the axial direction and the radial direction via the second rolling member group 60Gb.

According to the present embodiment, the electric actuator 100 includes the retaining members 61 and 62 that retain the rolling member group 60G in a state where the rolling member 60 is rotatable. Therefore, when the motor shaft 23 and the output shaft 46 are assembled, the retaining members 61 and 62 make it possible to suppress a defect such as falling of the rolling member 60 from occurring. This makes it possible to easily assemble the motor shaft 23 and the output shaft 46. Since the retaining members 61 and 62 can retain the rolling member 60, it is possible to suppress the relative position between the rolling members 60 from changing. This makes it possible to suppress the rolling members 60 from circumferentially approaching each other in each rolling member group 60G, and possible to suppress the circumferential position of the rolling member 60 from being biased. Therefore, it is possible to suitably maintain a state in which the motor shaft 23 and the output shaft 46 are supported by each other via the rolling member 60. Since it is not necessary to pave the rolling members 60 in the circumferential direction, the number of the rolling members 60 can be reduced. Therefore, the number of components of the electric actuator 100 can be reduced, and the manufacturing cost of the electric actuator 100 can be reduced.

According to the present embodiment, the retaining members 61 and 62 have the pressing parts 61a and 62a located on the radially outside of the rolling member 60 and the partition parts 61b and 62b located between the rolling members 60 adjacent to each other in the circumferential direction. Therefore, the pressing parts 61a and 62a make it possible to suppress the rolling member 60 from being detached radially outward from and falling off the retaining members 61 and 62. This makes it possible to assemble the motor shaft 23 and the output shaft 46 more easily. The partition parts 61b and 62b make it possible to suppress the positions of the rolling members 60 adjacent to each other in the circumferential direction from changing. This makes it possible to more suitably suppress the rolling members 60 from circumferentially approaching each other in each rolling member group 60G, and possible to more suitably suppress the circumferential position of the rolling member 60 from being biased.

According to the present embodiment, the retaining members 61 and 62 are made of resin. Therefore, even when the retaining members 61 and 62 are rubbed against the motor shaft 23 or the output shaft 46 when the motor shaft 23 and the output shaft 46 relatively rotate about the motor axis J1, the frictional force generated between each shaft and the retaining members 61 and 62 can be reduced. This makes it possible to suppress the relative rotation between the motor shaft 23 and the output shaft 46 from being inhibited by the retaining members 61 and 62.

The present invention is not limited to the above-described embodiment, and other configurations and methods can be adopted within the scope of the technical idea of the present invention. The motor shaft and the output shaft may be supported with each other in any manner as long as the motor shaft and the output shaft are supported with each other in the axial direction and the radial direction via the rolling member group. Only one rolling member group may be provided, or three or more rolling member groups may be provided. For example, in the above-described embodiment, at least one of the first rolling member group 60Ga and the second rolling member group 60Gb need not be provided. The number of rolling members included in the rolling member group is not particularly limited as long as it is three or more. When a plurality of rolling member groups are provided, the number of rolling members included in each rolling member group may be different from one another. When a plurality of rolling member groups are provided, the size of the rolling member included in one rolling member group may be different from the size of the rolling member included in another rolling member group.

The retaining member may have any shape as long as the rolling member group can be retained in a state where the rolling member is rotatable. The pressing part of the retaining member may be configured by the radially outer end part of the partition part, for example. In the above-described embodiment, the shape of the retaining member 61 retaining the first rolling member group 60Ga and the shape of the retaining member 62 retaining the second rolling member group 60Gb may be different from each other. The material constituting the retaining member is not particularly limited. The retaining member may be made of metal. The retaining member need not be provided. In this case, for example, the rolling member group may be assembled in a state where the plurality of rolling members included in the rolling member group are retained by grease or the like having relatively high viscosity.

The transmission mechanism is not particularly limited as long as the rotation of the motor shaft can be transmitted to the output shaft. The transmission mechanism may be a speed increasing mechanism or may be a mechanism that does not shift the rotation of the motor shaft. When the transmission mechanism is a speed reduction mechanism, the structure of the speed reduction mechanism is not particularly limited. The plurality of protrusion parts may be provided in the external gear, and the plurality of hole parts may be provided in the output flange part. In this case, the protrusion part protrudes from the external gear toward the output flange part and is inserted into the hole part.

The application of the electric actuator to which the present invention is applied is not particularly limited. The electric actuator may be equipped on a shift-by-wire type actuator device driven based on a shift operation of the driver. The electric actuator may be equipped on equipment other than a vehicle. The configurations described in the present description can be appropriately combined within a range not contradictory to one another.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. An electric actuator comprising:
a motor including a motor shaft rotatable about a motor axis;
a transmission mechanism coupled to one side in an axial direction of the motor shaft;
an output shaft extending in an axial direction of the motor shaft and to which rotation of the motor shaft is transmitted via the transmission mechanism; and
a rolling member group including three or more rolling members arranged to surround the motor axis, wherein
the motor shaft is a hollow shaft,
at least a part of the output shaft is located inside the motor shaft, and
the motor shaft and the output shaft are supported with each other in an axial direction and a radial direction via the rolling member group.

2. The electric actuator according to claim 1, wherein
the motor includes a rotor body fixed to an outer peripheral surface of the motor shaft, and
the rolling member group includes
a rolling member group located on one side in an axial direction relative to the rotor body, and
a rolling member group located on another side in an axial direction relative to the rotor body.

3. The electric actuator according to claim 1, wherein
an inner peripheral surface of the motor shaft is provided with a first step part including a first step surface facing one side in an axial direction,
an outer peripheral surface of the output shaft is provided with a second step part including a second step surface facing another side in an axial direction and located on one side in an axial direction of the first step surface,
the first step surface includes a first contact surface facing one side in an axial direction and an obliquely radial inside,
the second step surface includes a second contact surface facing another side in an axial direction and an obliquely radial outside,
the rolling member group includes a first rolling member group located between the first contact surface and the second contact surface, and
the rolling member included in the first rolling member group is in contact with the first contact surface and the second contact surface.

4. The electric actuator according to claim 3, wherein the first contact surface and the second contact surface have a shape along a surface of the rolling member included in the first rolling member group.

5. The electric actuator according to claim 1, wherein
an end surface of the motor shaft on another side in an axial direction includes a third contact surface facing another side in an axial direction and an obliquely radial outside,
the output shaft is passed inside the motor shaft, protrudes to another side in an axial direction relative to the motor shaft, and includes an opposing part disposed to oppose another side in an axial direction of the motor shaft,
the opposing part includes a fourth contact surface facing one side in an axial direction and radially inward,
the rolling member group includes a second rolling member group located between the third contact surface and the fourth contact surface, and
the rolling member included in the second rolling member group is in contact with the third contact surface and the fourth contact surface.

6. The electric actuator according to claim 5, wherein the third contact surface and the fourth contact surface have a shape along a surface of the rolling member included in the second rolling member group.

7. The electric actuator according to claim 1, further comprising a retaining member that retains the rolling member group in a state where the rolling member is rotatable.

8. The electric actuator according to claim 7, wherein
the retaining member includes
a pressing part located on a radially outer side of the rolling member, and
a partition part located between the rolling members adjacent to each other in a circumferential direction.

9. The electric actuator according to claim 7, wherein the retaining member is made of resin.
